(19) United States
(12) Patent Application Publication
(10) Pub. No.: US 2008/0294844 A1
(43) Pub. Date: Nov. 27, 2008

(54) Storage controller managing logical volume

(76) Inventor: Yasuo Yamasaki, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/213,394

(22) Filed: Jun. 19, 2008

Related U.S. Application Data
(63) Continuation of application No. 11/082,864, filed on Mar. 18, 2005, now abandoned.

(30) Foreign Application Priority Data
Jan. 13, 2005 (JP) 2005-006149

(51) Int. Cl. G06F 12/08

(52) U.S. Cl. 711/114; 711/E12.019

(57) ABSTRACT

A storage controller is provided to prevent access performance from dropping. The storage controller comprises a processor unit, a network controller, and a cache memory, and a disk controller connected to a logical volume. The processor unit includes: a file creating module which creates a file in the logical volume; an arrangement information management module which manages information on an arrangement of the file created in the logical volume; and a file presenting module which presents the file as a virtual volume based on the arrangement information stored in the cache memory.

### CLAIM OF PRIORITY

The present application is a continuation application to U.S. patent application Ser. No. 11/082,864, filed Mar. 18, 2005 which claims priority from Japanese patent application P2005-6149 filed on Jan. 13, 2005, the content of which is hereby incorporated by reference into this application.

### BACKGROUND

This invention relates to a storage controller to control logical volumes via a network, and more specifically to a technique of integrating volumes.

Conventional computer systems use a Direct Attached Storage (DAS). DAS is a storage connected directly to a server. In a computer system that uses DAS, storage systems are managed separately. An increase in amount of data stored in storage systems of a computer system that uses DAS accordingly raises the cost of managing the storage systems.

Recent computer systems avoid this problem by connecting storage systems to a Storage Area Network (SAN) and employing a network storage system such as a Network Attached Storage (NAS). With SAN and NAS, storages are integrated to be managed in a centralized manner and the management cost is thus cut down.

Another known solution is to provide a remote site volume virtually with the use of iSCSI (see U.S. Pat. No. 6,748,502, for example).

Blade servers have lately been replacing rackmount servers. However, a blade server is mounted with many servers at high density, making it laborious to manage storage systems the blade server accesses.

For instance, volume management is not easy since there are numerous volumes in storage systems connected to a SAN which are processed by a blade server. Volume management includes taking a backup, capacity monitoring, capacity expansion, remote copying, archiving, replacing a failed disk drive, and dealing with compliance.

Compared to the storage systems connected to the SAN, a NAS processed by the blade server has an inferior file system function. Specifically, the NAS processed by the blade server cannot use high-level access control, high-level exclusive access processing, rich metadata, the data encryption function, the journaling function, etc.

A solution proposed is to apply a loopback device, which is used in a Linux operating system, to NAS. A loopback device in a Linux operating system makes a file seem as if it is a virtual volume.

For instance, a NAS creates many small files in one huge logical volume. The NAS then uses a loopback device to make each of the created files look like a virtual volume. The NAS presents the virtual volumes to a blade server with the use of a block access interface such as iSCSI or Fibre Channel. In this way, the NAS can integrate volumes without sacrificing the file system function.

### SUMMARY

According to the conventional techniques drawback of a NAS employing a loopback device is poor access performance. This is because the NAS, upon receiving virtual block access from the blade server, converts the virtual block access to a file access and then to physical block access.

It is therefore an object of this invention to keep the access performance in a network storage system from dropping.

According to an embodiment of the present invention, there is provided a storage controller, comprising: a processor unit; a network controller connected thereto; and a disk controller connected to a logical volume; wherein, the processor unit includes: a file creating module which creates a file in the logical volume; an arrangement information management module which manages information on an arrangement of the file created in the logical volume; and a file presenting module which presents the file as a virtual volume based on the arrangement information.

According to the embodiment of this invention, the access performance in a network storage system is prevented from dropping.

### BRIEF DESCRIPTION OF THE DRAWINGS

The present invention can be appreciated by the description which follows in conjunction with the following figures, wherein:

FIG. 1 is a block diagram showing a configuration of an integrated NAS system according to an embodiment of this invention;

FIG. 2 is a configuration diagram of a virtual volume management program stored in a processor unit according to the embodiment of this invention;

FIG. 3 is a configuration diagram of an iSCSI target processing program stored in the processor unit according to the embodiment of this invention;

FIG. 4 is a configuration diagram of a file system processing program stored in the processor unit according to the embodiment of this invention;

FIG. 5 is a configuration diagram of a virtual volume management table stored in the processor unit according to the embodiment of this invention;

FIG. 6 is a configuration diagram of a cache management table stored in the processor unit according to the embodiment of this invention;

FIG. 7 is an explanatory diagram of processing executed, in the event of a cache miss, by the integrated NAS system according to the embodiment of this invention;

FIG. 8 is an explanatory diagram of processing executed, in the event of a cache hit, by the integrated NAS system according to the embodiment of this invention;

FIG. 9 is a flow chart of processing of an iSCSI read/write routine which is contained in the iSCSI target processing program according to the embodiment of this invention;

FIG. 10 is a flow chart of processing of a file read/write routine which is contained in the file system processing program according to the embodiment of this invention;

FIG. 11 shows processing executed by the integrated NAS system upon reception of a virtual volume allocation instruction from a management terminal;

FIG. 12 is a flow chart of processing of a virtual volume allocation routine which is contained in the virtual volume management program according to the embodiment of this invention;

FIG. 13 shows processing executed by the integrated NAS system upon reception of an attachment instruction from an iSCSI host;

FIG. 14 is a flow chart of processing of an iSCSI attachment routine which is contained in the iSCSI target processing program according to the embodiment of this invention;

FIG. 15 is an explanatory diagram of file copy processing of the integrated NAS system according to the embodiment of this invention;

FIG. 16 is an explanatory diagram of a logical volume in which a file having a hole is stored according to the embodiment of this invention;

FIG. 17 is a flow chart of processing of a back-up routine which is contained in the file system processing program according to the embodiment of this invention;

FIG. 18 is an explanatory diagram of automatic back-up processing of the integrated NAS system according to the embodiment of this invention;

FIG. 19 is a flow chart of processing of an iSCSI detachment routine which is contained in the iSCSI target processing program according to the embodiment of this invention;

FIG. 20 is an explanatory diagram of restoration processing of the integrated NAS system according to the embodiment of this invention; and

FIG. 21 is a flow chart of processing of a restoration routine which is contained in the virtual volume management program according to the embodiment of this invention.

### DETAILED DESCRIPTION OF THE PREFERRED EMBODIMENT

An embodiment of this invention will be described below with reference to the accompanying drawings.

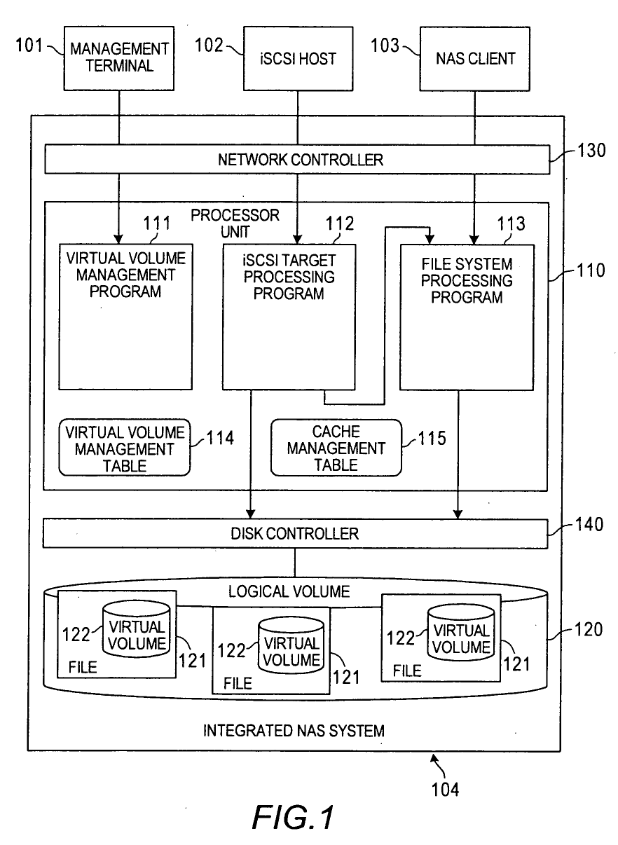

FIG. 1 is a block diagram showing a configuration of an integrated NAS system 104 according to this embodiment.

The integrated NAS system 104 is composed of a disk controller and a disk array. The disk controller has a processor unit 110, a network controller 130 and a disk controller 140. The disk array has plural disk drives, and constitutes a logical volume 120.

The network controller 130 is connected via a network (e.g., Ethernet (registered trademark)) to a management terminal 101, an iSCSI host 102 and a NAS client 103. The network controller 130 here is a TCP/IP protocol engine.

The management terminal 101 manages the logical volume 120. The iSCSI host 102 is, for example, a blade server, and uses an iSCSI protocol to access the logical volume 120 and read/write data stored in the logical volume 120. The NAS client 103 is, for example, a blade server, and uses a file system processing program 113 in the integrated NAS system 104 to access the logical volume 120 and read/write data in the logical volume 120.

The disk controller 140 controls data inputted to and outputted from the logical volume 120. The logical volume 120 stores plural files 121. The files 121 are recognized by the NAS client 103 whereas the iSCSI host 102 recognizes the files 121 not as files but as virtual volumes 122. Alternatively, the iSCSI host 102 may recognizes one file 121 as plural virtual volumes 122.

The processor unit 110 has a CPU, a cache memory, and a memory. The memory stores various control programs, which are executed by the CPU. The processor unit 110 thus manages the logical volume 120 and executes data input/output in the logical volume 120 upon request from the management terminal 101, the iSCSI host 102 and the NAS client 103. The cache memory temporarily stores data to be inputted to and outputted from the logical volume 120. The cache memory stores a virtual volume management table 114 and a cache management table 115.

The processor unit 110 is connected to the network controller 130 and the disk controller 140. The processor unit 110 contains a virtual volume management program 111, an iSCSI target processing program 112, the file system processing program 113, the virtual volume management table 114 and the cache management table 115.

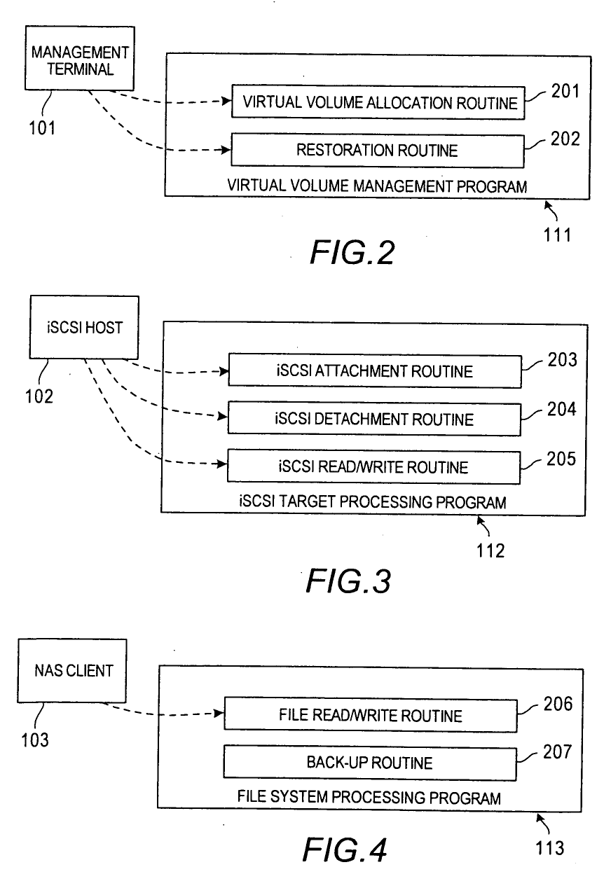

The virtual volume management program 111 contains a routine described later with reference to FIG. 2, and manages the virtual volumes 122 as instructed by the management terminal 101. The iSCSI target processing program 112 contains a routine described later with reference to FIG. 3, and processes an instruction from the iSCSI host 102. The file system processing program 113 contains a routine described later with reference to FIG. 4, and accesses the files 121 stored in the logical volume 120.

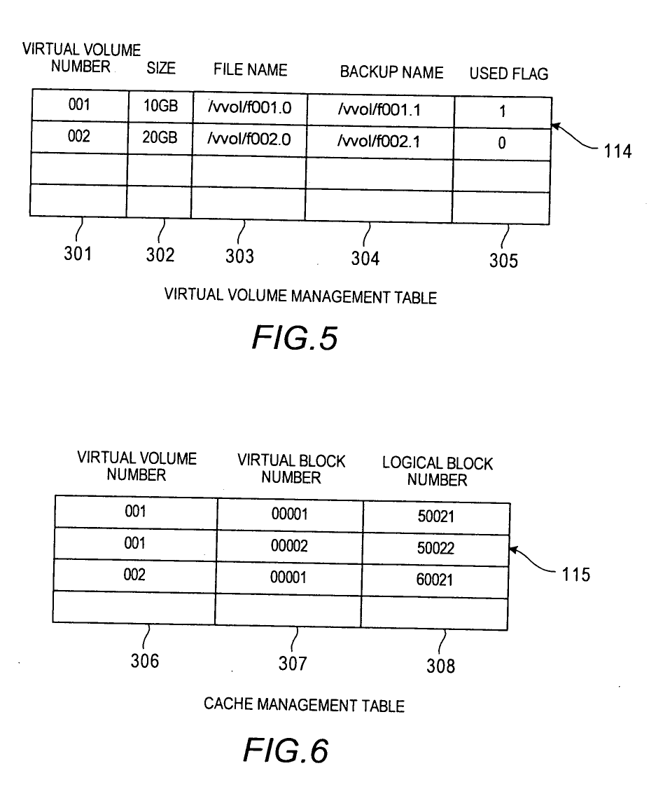

The virtual volume management table 114 is, as will be described later with reference to FIG. 5, for management of various types of information of the virtual volumes 122. For instance, the virtual volume management table 114 holds information about which one of the virtual volumes 122 is associated with which one of the files 121. The cache management table 115 is, as will be described later with reference to FIG. 6, for management of locations where the virtual volumes 122 are stored.

FIG. 2 is a configuration diagram of the virtual volume management program 111 stored in the processor unit 110 according to this embodiment.

The virtual volume management program 111 contains a virtual volume allocation routine 201 and a restoration routine 202.

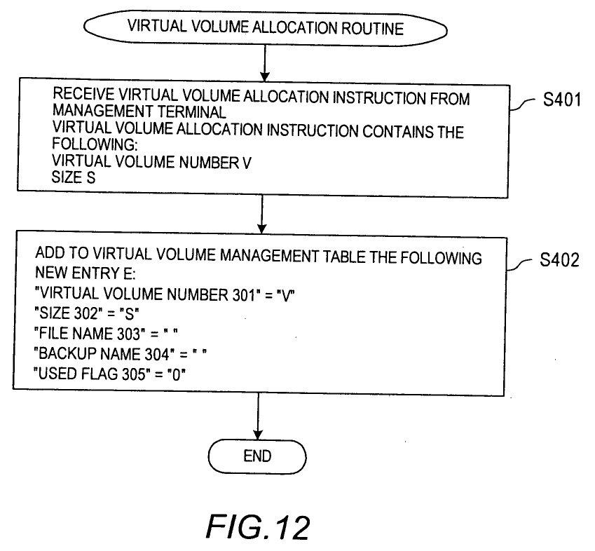

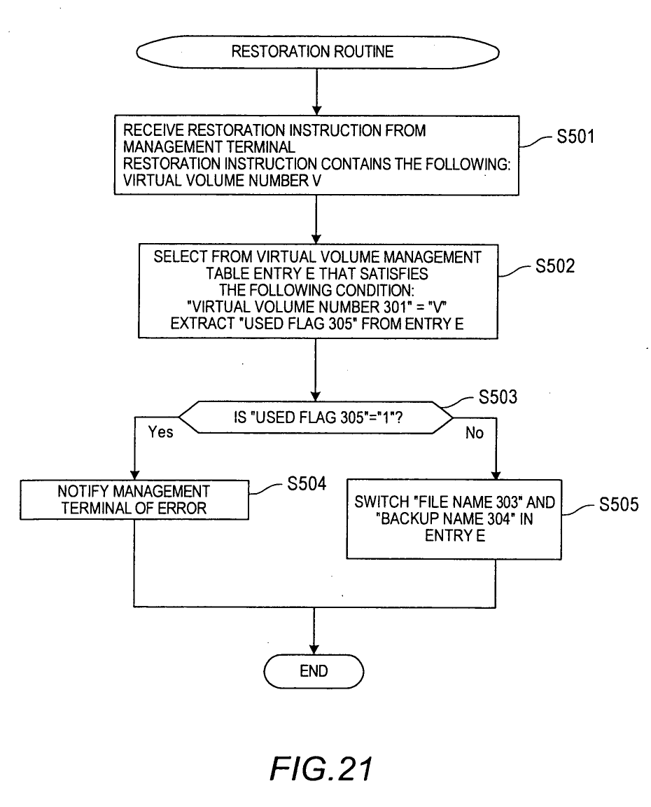

The virtual volume allocation routine 201 stores, upon receiving a virtual volume allocation instruction from the management terminal 101, the contents of the instruction in the virtual volume management table 114 as shown in FIG. 12. The restoration routine 202 switches the files 121 and backup files as shown in FIG. 21 upon receiving a restoration instruction from the management terminal 101.

FIG. 3 is a configuration diagram of the iSCSI target processing program 112 stored in the processor unit 110 according to this embodiment.

The iSCSI target processing program 112 contains an iSCSI attachment routine 203, an iSCSI detachment routine 204 and an iSCSI read/write routine 205.

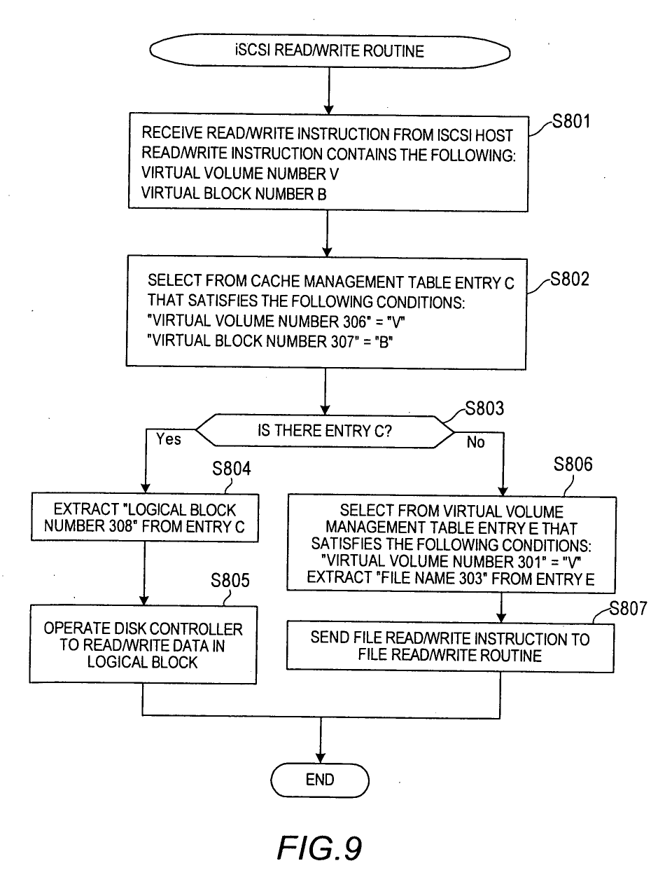

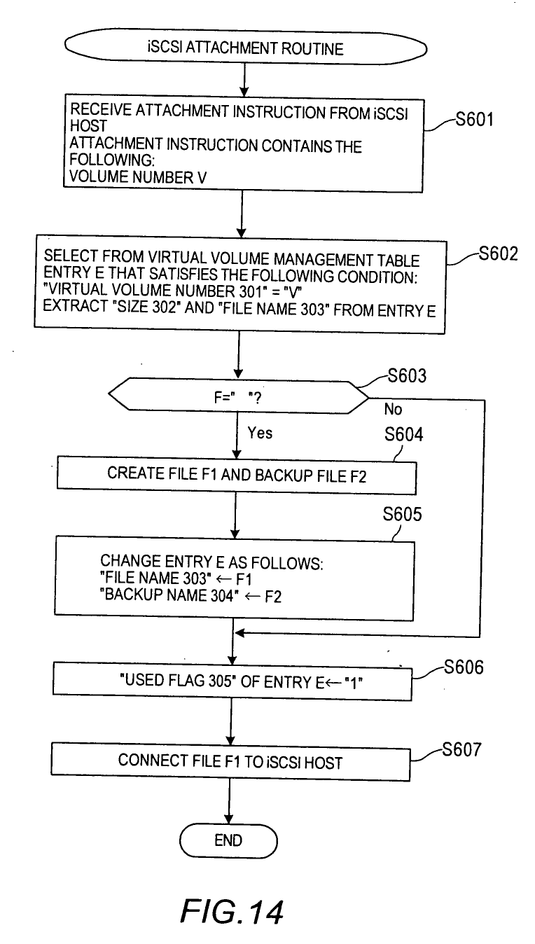

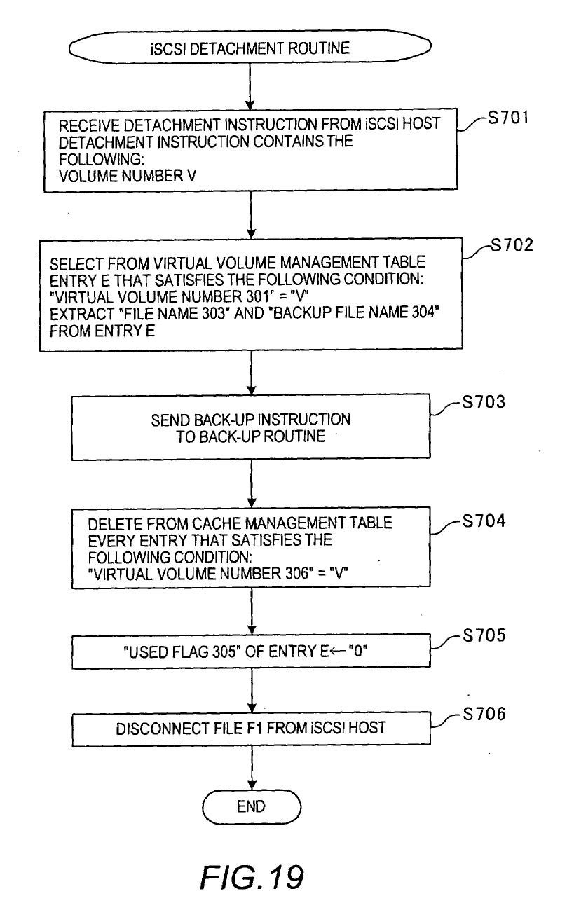

The iSCSI attachment routine 203 connects, upon receiving an attachment instruction from the iSCSI host 102, one of the virtual volumes 122 that is specified by the attachment instruction to the iSCSI host 102 as shown in FIG. 14. The iSCSI detachment routine 204 disconnects, upon receiving a detachment instruction from the iSCSI host 102, one of the virtual volumes 122 that is specified by the detachment instruction from the iSCSI host 102 as shown in FIG. 19. The iSCSI read/write routine 205 receives a read/write instruction from the iSCSI host 102, and reads/writes data in one of the virtual volumes 122 that is specified by the read/write instruction as shown in FIG. 9.

FIG. 4 is a configuration diagram of the file system processing program 113 stored in the processor unit 110 according to this embodiment.

The file system processing program 113 contains a file read/write routine 206 and a back-up routine 207.

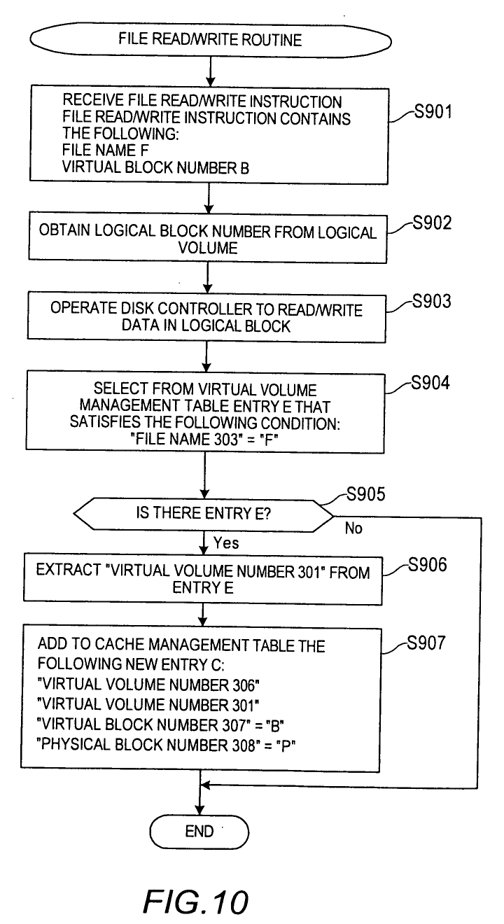

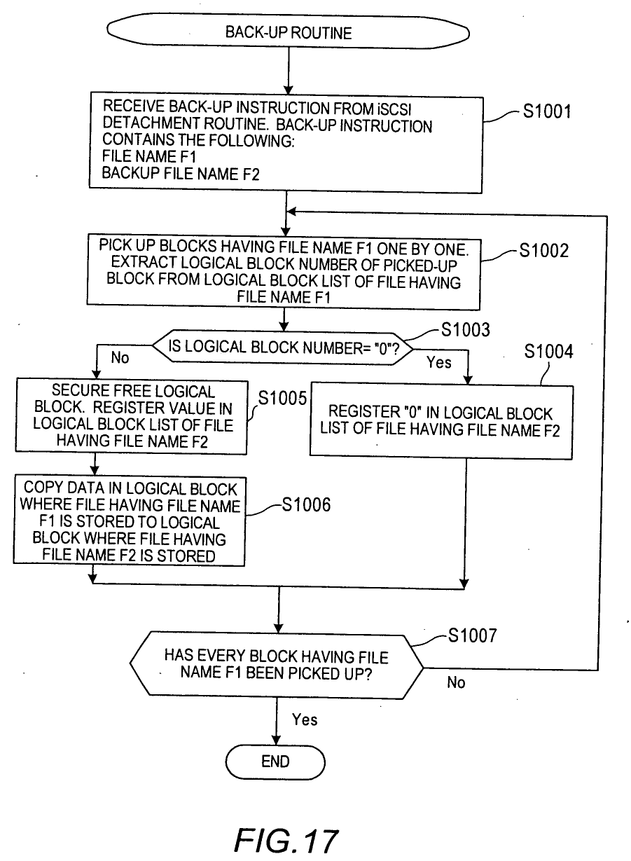

The file read/write routine 206 receives a file read/write instruction from the NAS client 103 or others, and reads/writes data in one of the files 121 that is specified by the file read/write instruction as shown in FIG. 10. The back-up routine 207 receives a back-up instruction from the iSCSI target processing program 112, and backs up one of the files 121 that is specified by the back-up instruction as shown in FIG. 17.

FIG. 5 is a configuration diagram of the virtual volume management table 114 stored in the processor unit 110 according to this embodiment.

The virtual volume management table 114 contains a virtual volume number 301, a size 302, a file name 303, a backup name 304 and a used flag 305.

The virtual volume number 301 is an identifier unique to each of the virtual volumes 122, and LUN (Logical Unit Number), for example, is employed as the virtual volume number 301. The size 302 indicates the storage capacity of one of the virtual volumes 122 that is identified by the virtual volume number 301.

The file name 303 is the name of one of the files 121 that is associated with this virtual volume, and also contains a path name. The files 121 associated with the virtual volumes 122 are the virtual volumes 122 as recognized by the NAS client 103. The backup name 304 is the name of a backup file which is a backup of this file, and also contains a path name.

The used flag 305 indicates whether this virtual volume is connected with the iSCSI host 102 or not. When this virtual volume is connected to the iSCSI host 102, “1” is held in the field of the used flag 305 whereas “0” is held in the field of the used flag 305 when this volume is disconnected from the iSCSI host 102.

FIG. 6 is a configuration diagram of the cache management table 115 stored in the processor unit 110 according to this embodiment.

The cache management table 115 contains a virtual volume number 306, a virtual block number 307 and a logical block number 308.

The virtual volume number 306 is an identifier unique to each of the virtual volumes 122, and LUN, for example, is employed as the virtual volume number 306. The virtual block number 307 indicates a location in the virtual volumes 122, and serves as an identifier used by the iSCSI host 102 to uniquely identify a virtual block in the virtual volume that is identified by the virtual volume number 306. The logical block number 308 indicates a location in the logical volume 120, and serves as an identifier unique to a logical block that is associated with the virtual block identified by the virtual block number 307.

Described next is processing executed in the NAS system 104 according to this embodiment.

### (Read/Write Processing)

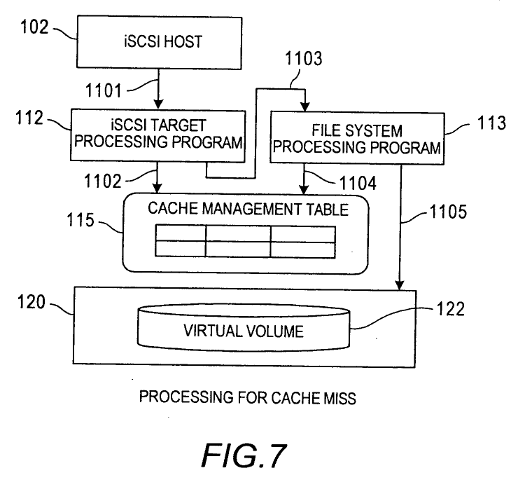

FIG. 7 is an explanatory diagram of processing executed, in the event of a cache miss, by the integrated NAS system 104 according to this embodiment.

A cache miss refers to data of a virtual block to be read/written by the iSCSI host 102 not being stored in the cache. In other words, a cache miss refers to the number of a virtual block to be read/written not being found in the cache management table 115.

First, the iSCSI target processing program 112 receives a read/write instruction, which contains a virtual volume number and a virtual block number, from the iSCSI host 102 (1101).

The iSCSI target processing program 112 next makes a cache hit/miss judgment in which whether or not the cache management table 115 can provide a logical block number requested by the read/write instruction is judged (1102). Specifically, the iSCSI target processing program 112 judges whether or not the virtual volume number contained in the read/write instruction matches any virtual volume number 306 of the cache management table 115, and whether or not the cache management table 115 has an entry whose virtual block number 307 matches the virtual block number contained in the read/write instruction.

In the case shown in FIG. 7, the cache management table 115 has no entry whose virtual volume number and virtual block number match those contained in the received read/write instruction. The iSCSI target processing program 112 accordingly judges that the logical block number requested by the read/write instruction cannot be retrieved from the cache management table 115 (a cache miss).

Then the iSCSI target processing program 112 selects an entry of the virtual volume management table 114 whose virtual volume number 301 matches the virtual volume number contained in the read/write instruction, and extracts the file name 303 of this entry from the virtual volume management table 114. The iSCSI target processing program 112 calls up the file system processing program 113, and sends the extracted file name 303 and the virtual block number contained in the read/write instruction to the file system processing program 113 (1103).

The file system processing program 113 multiplies the received virtual block number by a virtual block size to calculate a file offset. A virtual block size is the capacity of a virtual block and is set in advance. The file system processing program 113 may receive from the iSCSI target processing program 112 a file offset instead of the file block number.

Next, the file system processing program 113 obtains a logical block number from the received file name and the calculated file offset. The file system processing program 113 then chooses an entry of the virtual volume management 114 whose file name 303 matches the received file name, and extracts the virtual volume number 301 of this entry from the virtual volume management table 114. The extracted virtual volume number 301, the received virtual block number, and the obtained logical block number are entered in the cache management table 115 by the file system processing program 113 (1104).

The file system processing program 113 then reads/writes data at the location of the obtained logical block number (1105).

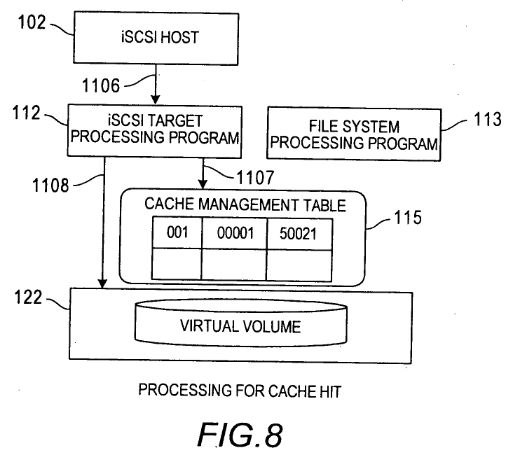

FIG. 8 is an explanatory diagram of processing executed, in the event of a cache hit, by the integrated NAS system 104 according to this embodiment.

A cache hit refers to data of a virtual block to be read/written by the iSCSI host 102 being stored in the cache. In other words, a cache hit refers to the number of a virtual block to be read/written being found in the cache management table 115.

First, the iSCSI target processing program 112 receives a read/write instruction, which contains a virtual volume number and a virtual block number, from the iSCSI host 102 (1106).

The iSCSI target processing program 112 next makes a cache hit/miss judgment. In the case shown in FIG. 8, the iSCSI target processing program 112 judges that the logical block number requested by the read/write instruction can be retrieved from the cache management table 115 (a cache hit).

Next, the iSCSI target processing program 112 selects an entry of the cache management table 115 whose virtual volume number 306 matches the virtual volume number contained in the read/write instruction and whose virtual block number 307 matches the virtual block number contained in the read/write instruction. From the chosen entry, the iSCSI target processing program 112 extracts the logical block number 308 (1107).

The iSCSI target processing program 112 then reads/writes data at the location of the extracted logical block number 308 (1108).

FIG. 9 is a flow chart of processing of the iSCSI read/write routine 205 which is contained in the iSCSI target processing program 112 according to this embodiment.

The iSCSI read/write routine 205 receives a read/write instruction from the iSCSI host 102 and starts processing (S801).

The iSCSI read/write routine 205 then selects an entry C of the cache management table 115 whose virtual volume number 306 matches a virtual volume number V contained in the read/write instruction and whose virtual block number 307 matches a virtual block number B contained in the read/write instruction (S802).

Next, the iSCSI read/write routine 205 judges whether the selectable entry C is present or not (S803).

When the selectable entry C is judged to be present, the iSCSI read/write routine 205 judges that the logical volume 120 can be accessed directly without the intermediation of the file system processing program 113, and accordingly extracts the logical block number 308 from the selected entry C (S804). The disk controller 140 is operated to read/write data in the logical block that is identified by the extracted logical block number 308 (S805).

On the other hand, when it is judged in the step S803 that the selectable entry C is not present, the logical volume 120 cannot be accessed directly, and accordingly the iSCSI read/write routine 205 accesses the logical volume 120 via the file system processing program 113. Through the access, the iSCSI read/write routine 205 chooses an entry E of the virtual volume management table 114 whose virtual volume number 301 matches the virtual volume V contained in the read/write instruction. From the selected entry E, the file name 303 is extracted (S806).

Then a file read/write instruction is sent to the file read/write routine 206 (S807). The file read/write instruction contains the extracted file name 303 and the virtual block number B contained in the read/write instruction.

The iSCSI read/write routine 205 thus accesses, upon reception of a read/write instruction that is a cache hit, the logical volume 120 directly without the intermediation of the file system processing program 113. In this way, the integrated NAS system 104 enhances the speed of access.

FIG. 10 is a flow chart of processing of the file read/write routine 206 which is contained in the file system processing program 113 according to this embodiment.

The file read/write routine 206 receives a read/write instruction from the NAS client 103 or from the iSCSI read/write routine 205, and starts processing (S901).

The file read/write routine 206 then multiplies the virtual block number B contained in the read/write instruction by a virtual block size to calculate a file offset. The virtual block size is set in advance. The read/write instruction may contain a file offset instead of the virtual block number B. Next, the file read/write routine 206 obtains a logical block number from a file name F contained in the read/write instruction and the calculated file offset (S902).

The disk controller 140 is operated to read/write data in a logical block that is identified by the obtained logical block number (S903).

Then the file read/write routine 206 selects the entry E of the virtual volume management table 114 whose file name 303 matches the file name F contained in the read/write instruction (S904).

Next, the file read/write routine 206 judges whether the selectable entry E is present in the virtual volume management table 114 or not (S905).

When it is judged that the selectable entry E is not present, it means that the read/write instruction has been sent from the NAS client 103 and that there is no need to register the obtained logical block number in the cache management table 115. The processing is therefore ended.

On the other hand, when the selectable entry E is judged to be present, it means that the read/write instruction has been sent from the iSCSI read/write routine 205, and the obtained logical block number is registered in the cache management table 115.

Specifically, the virtual volume number 301 is extracted from the selected entry E (S906). Next, the new entry C is added to the cache management table 115. The extracted virtual volume number 301 is stored as the virtual volume number 306 of the new entry C. The virtual block number B contained in the read/write instruction is stored as the virtual block number 307 of the new entry C. The logical block number obtained in the step S903 is stored as the logical block number 308 of the new entry C.

The file read/write routine 206 thus enters the association relation between a virtual block and a logical block in the cache management table 115.

Conventional NAS systems perform the processing for a cache miss shown in FIG. 7 on every read/write instruction received from the iSCSI host 102. In other words, a virtual block number is converted to file access and then to a physical block number each time. This is why it is difficult to improve the access performance with conventional NAS systems.

In contrast, the iSCSI target processing program 112 of this embodiment accesses the volume without the intermediation of the file system processing program 113 upon reception of a read/write instruction that is a cache hit. In short, the iSCSI target processing program 112 is capable of direct conversion from a virtual block number to a physical block number. The integrated NAS system 104 of this embodiment thus enhances the access speed.

### (Delay Allocation Processing)

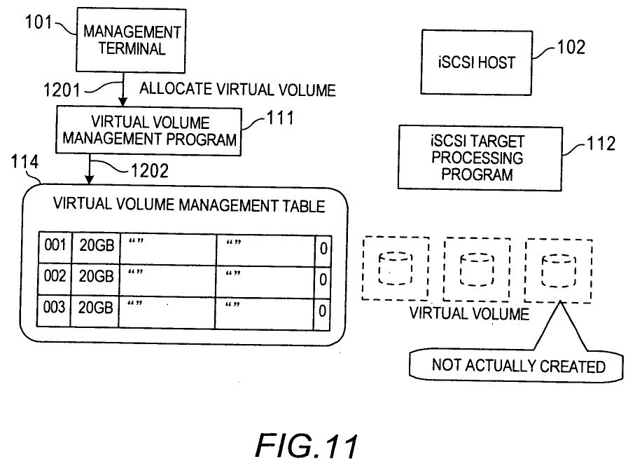

FIGS. 11 to 14 are explanatory diagrams of delay allocation processing of the integrated NAS system 104 according to this embodiment.

FIG. 11 shows processing executed by the integrated NAS system 104 upon reception of a virtual volume allocation instruction from the management terminal 101.

First, the virtual volume management program 111 receives a virtual volume allocation instruction from the management terminal 101 (1201). A virtual volume allocation instruction contains a virtual volume number and a virtual volume size. The virtual volume allocation instruction in this explanatory diagram requests allocation of three of the virtual volumes 122.

The virtual volume management program 111 next enters in the virtual volume management table 114 the virtual volume numbers and the virtual volume sizes that are contained in the virtual volume allocation instruction (1202). Then the virtual volume management program 111 ends the processing without really securing storage areas for the virtual volumes (without creating the virtual volumes 122).

FIG. 12 is a flow chart of processing of the virtual volume allocation routine 201 which is contained in the virtual volume management program 111 according to this embodiment.

The virtual volume allocation routine 201 receives a virtual volume allocation instruction from the management terminal 101, and starts processing (S401).

Receiving the virtual volume allocation instruction, the virtual volume allocation routine 201 adds the new entry E to the virtual volume management table 114. The virtual volume number V contained in the virtual volume allocation instruction is stored as the virtual volume number 301 of the added new entry E. A size S contained in the virtual volume allocation instruction is stored as the size 302 of the added new entry E. Fields of the file name 303 and the backup name 304 in the new entry E remain blank. “0” is stored as the used flag 305 of the new entry E (S402). Thereafter, the virtual volume allocation routine 201 ends the processing.

As has been described, a virtual volume allocation instruction sent from the management terminal 101 only causes the virtual volume allocation routine 201 to enter the contents of the instruction in the virtual volume management table 114 without actually creating the virtual volumes 122.

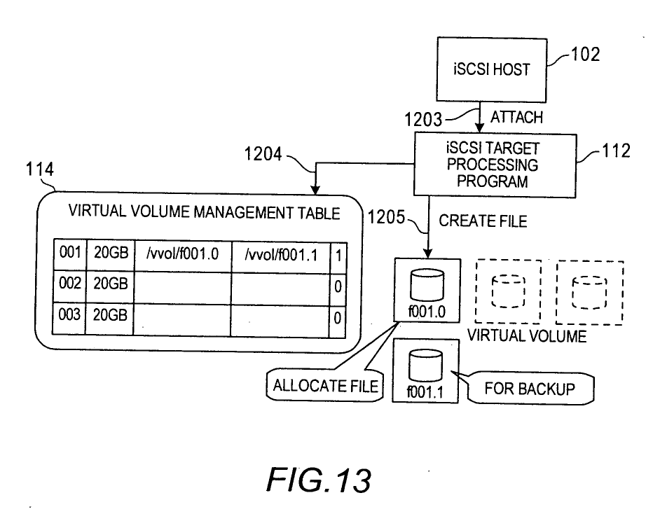

FIG. 13 shows processing executed by the integrated NAS system 104 upon reception of an attachment instruction from the iSCSI host 102.

First, the iSCSI target processing program 112 receives an attachment instruction, which contains a virtual volume number, from the iSCSI host 102 (1203).

Next, the iSCSI target processing program 112 refers to the virtual volume management table 114 to judge whether the virtual volumes 122 to be attached have already been created or not (1204). Specifically, the iSCSI target processing program 112 selects an entry of the virtual volume management table 114 whose virtual volume number 301 matches the virtual volume number contained in the attachment instruction and judges whether or not the file name 303 of the selected entry is listed in the table.

In this explanatory diagram, the virtual volumes 122 to be attached have not been created actually but merely their virtual volume numbers are stored in the virtual volume management table 114. Accordingly, the iSCSI target processing program 112 creates two virtual volumes 122 having the same size. The iSCSI target processing program 112 sets one of the created virtual volumes 122 as a file and the other of the created virtual volumes 122 as a backup file (1205). For two virtual volumes 122 that are yet to be attached, no storage areas are secured but merely their virtual volume numbers are stored in the virtual volume management table 114.

FIG. 14 is a flow chart of processing of the iSCSI attachment routine 203 which is contained in the iSCSI target processing program 112 according to this embodiment.

First, the iSCSI attachment routine 203 receives an attachment instruction from the iSCSI host 102, and starts processing (S601).

The iSCSI attachment routine 203 next selects the entry E of the virtual volume management table 114 whose virtual volume number 301 matches the virtual volume number V contained in the attachment instruction. From the selected entry E, the iSCSI attachment routine 203 extracts the size 302 and the file name 303 (S602).

Then the iSCSI attachment routine 203 judges whether the field of the extracted file name 303 is blank or not (S603).

When the field of the file name 303 holds a value, it means that the files 121 that are to be attached by the iSCSI host 102 have already been created, and the processing proceeds to a step S606.

On the other hand, when the field of the file name 303 is blank, the iSCSI attachment routine 203 judges that the files 121 to be attached by the iSCSI host 102 have not been created. Accordingly, two storage areas each having the extracted size 302 are set aside to create two virtual volumes 122 of the same size. The iSCSI attachment routine 203 sets one of the created virtual volumes 122 as a file and the other of the created virtual volumes 122 as a backup file (S604). The iSCSI attachment routine 203 then determines a file name F1 of the created file and a file name F2 of the backup file. The file names F1 and F2 may be automatically determined in accordance with an arbitrarily chosen rule, or may be inputted from the iSCSI host 102. For instance, the file names F1 and F2 in this embodiment are determined based on the virtual volume numbers of the virtual volumes 122 where the file and the backup file are created.

Next, the file name F1 is stored as the file name 303 of the selected entry E whereas the file name F2 is stored as the backup name 304 of the entry E (S605). Then “1” is stored as the used flag 305 of the entry E (S606).

The iSCSI attachment routine 203 now connects the file having the file name F1 to the iSCSI host 102 (S607), and ends the processing.

Thus the iSCSI attachment routine 203 creates the virtual volumes 122 allocated by the management terminal 101 when those virtual volumes 122 are to be accessed for the first time.

Conventional NAS systems create a virtual volume as soon as a virtual volume allocation instruction is received. However, it is often the case that the iSCSI host does not use the created virtual volume immediately. Allocating a storage area of a logical volume to a virtual volume that is not in use as in conventional NAS systems is not conductive to efficient utilization of logical volumes.

The integrated NAS system 104 of this embodiment therefore does not secure storage areas to create the virtual volumes 122 immediately after receiving a virtual volume allocation instruction, but puts off creating the virtual volumes 122 until the virtual volumes 122 are to be accessed by the iSCSI host 102. The integrated NAS system 104 of this embodiment thus improves the utilization ratio of the logical volume 120 by delaying creating the virtual volumes 122.

### (File Copy Processing)

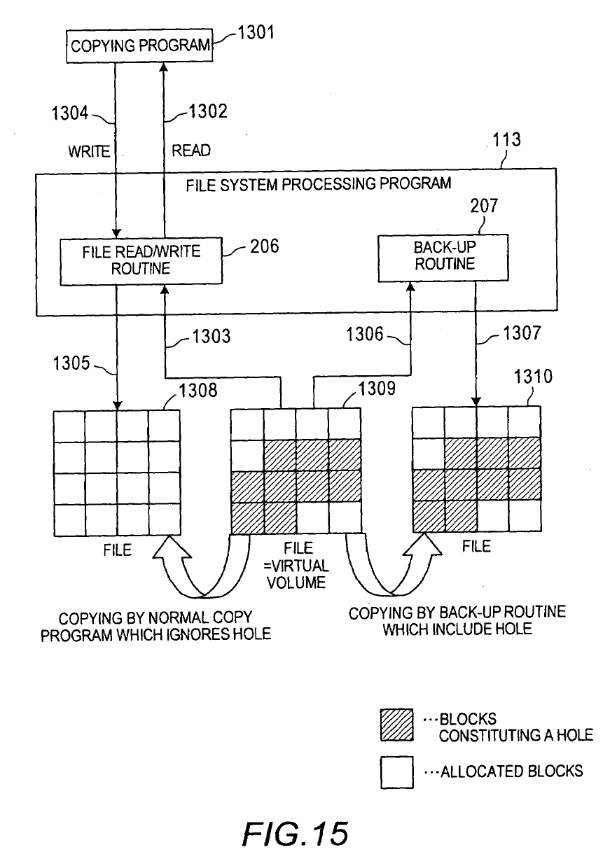

FIG. 15 is an explanatory diagram of file copy processing of the integrated NAS system 104 according to this embodiment.

Conventional file copying ignores a hole in a file. In contrast, copying in the integrated NAS system 104 of this embodiment takes a file hole into account.

First, a description will be given on a file hole.

The term hole refers to an area to which no logical volume 120 is allocated. General operating systems (unix, for example) is provided with a technique of creating a hole.

For instance, a sparse file is sometimes created in technical calculation or the like. A sparse file is a file covering an enormous area only a small portion of which is accessed. Allocating the logical volume 120 throughout the entire area of a sparse file lowers the utilization ratio of the logical volume 120. In addition, the access performance suffers from pointless access to the logical volume 120. Unix avoids these problems by creating a hole to which no logical volume 120 is allocated.

Described next is conventional file copy processing which ignores a file hole.

Here, a copying program 1301 copies a file 1309 to a file 1308. The copying program 1301 uses the file read/write routine 206, which is contained in the file system processing program 113, to make a copy of the file 1309.

Specifically, the copying program 1301 first instructs the file read/write routine 206 to read the file 1309 (1302). Receiving the read instruction, the file read/write routine 206 reads the file 1309 (1303). While reading the file 1309, the file read/write routine 206 also reads a hole in the file 1309 as zero data.

The copying program 1301 gives an instruction to write, in the file 1308, the file 1309 which has been read by the file read/write routine 206 (1304). Receiving the write instruction, the file read/write routine 206 writes the read file 1309 in the file 1308 (1305). At this point, the file read/write routine 206 writes, in the file 1308, as zero data, the hole of the file 1309 which has been read as zero data. This prevents the hole from being copied to the file 1308 and expands the wasted storage area.

As has been described, the conventional copying program 1301 copies a file without taking a hole into consideration (in other words, without copying the hole). To give an example, in the case where the conventional copying program 1301 takes a backup of a 100-GB file only 30 GB of which is in use (meaning that 70 GB of the file is a hole), the size of the backup file is 100 GB. Backing up with the conventional copying program 1301 thus lowers the utilization efficiency of the logical volume 120.

This embodiment solves the problem by giving the file system processing program 113 the back-up routine 207, which executes space-saving copying processing with a hole taken into account.

Before moving on to a description of the processing of the back-up routine 207, a description is given on how the logical volume 120 stores a file.

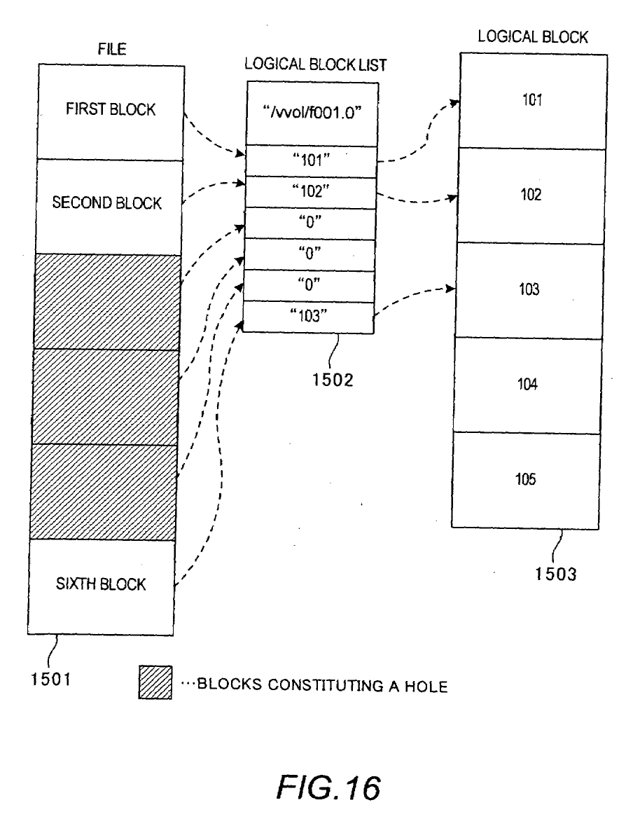

FIG. 16 is an explanatory diagram of the logical volume 120 in which a file having a hole is stored according to this embodiment.

A file 1501 stored in the logical volume 120 is composed of first through sixth blocks. The file 1501 contains a hole. For instance, the third, fourth and fifth blocks are a hole in the explanatory diagram of FIG. 16.

The logical volume 120 also stores a logical block list 1502, which has numbers of logical blocks allocated to the blocks of the file 1501. In the logical block list 1502, entries for the blocks that are a hole and associated with no logical blocks hold “0” instead of logical block numbers.

For example, the first block of the file 1501 is stored in a logical block having a logical block number “101”. Entries for the third through fifth blocks of the file 1501 which are a hole hold “0” in the logical block list 1502.

Now, returning to FIG. 15, the space-saving copying processing of the back-up routine 207 will be described.

In the explanatory diagram of FIG. 15, the back-up routine 207 copies the file 1309 to a file 1310.

First, the back-up routine 207 picks up the blocks in the file 1309 one by one to perform the following processing on each block separately.

Specifically, the back-up routine 207 obtains the logical block list 1502 of the file 1309 from the logical volume 120. Referring to the obtained logical block list 1502, the back-up routine 207 judges whether the picked up block is a hole or not.

When the picked up block is a hole, the back-up routine 207 writes “0” in an entry for this block in the logical block list of the file 1310.

On the other hand, when the picked up block is not a hole, the back-up routine 207 reads data stored in the picked up block of the file 1309 (1306). Next, the back-up routine 207 writes the read data in a logical block inside the logical volume 120 (1307). The back-up routine 207 enters, in the logical block list 1502 of the file 1310, the logical block number of the logical block in which the read data is written.

FIG. 17 is a flow chart of the processing of the back-up routine 207 which is contained in the file system processing program 113 according to this embodiment.

The back-up routine 207 receives a back-up instruction from the iSCSI detachment routine 204, and starts the processing (S1001). The back-up instruction contains the file name F1 and the backup file name F2.

The back-up routine 207 then picks up the blocks in the file having the file name F1 in an ascending order starting from the first block. The logical block number of a logical block that stores the picked up block is extracted from the logical block list of the file having the file name F1 (S1002).

The back-up routine 207 next judges whether the extracted logical block number is “0” or not (S1003).

When the extracted logical block number is “0”, the picked up block is a hole, and “0” is registered in the logical block list of the backup file having the backup file name F2 (S1004). The processing then proceeds to a step S1007.

On the other hand, when the extracted logical block number is not “0”, the picked up block is not a hole, and the back-up routine 207 accordingly secures a free logical block in the logical volume 120. The logical block number of the secured logical block is entered in the logical block list of the backup file having the backup file name F2 (S1005).

Then the back-up routine 207 copies data in the logical block where the file having the file name F1 is stored to the logical block where the backup file having the backup file name F2 is stored (S1006). Specifically, data in the logical block having the logical block number that has been extracted in the step S1002 is copied to the logical block that has been secured in the step S1005.

Next, the back-up routine 207 judges whether every block in the file having the file name F1 has been picked up in the step S1002 (S1007).

When every block in the file having the file name F1 has been picked up, copying this file is completed and the processing is ended.

When picking up every block in the file having the file name F1 is not finished, the back-up routine 207 judges that the file still has blocks left to be copied, and the processing returns to the step S1002.

In the manner described above, the back-up routine 207 takes a backup of a file while taking into account a hole in the file. This gives a size of 30 GB to a backup file of a 100-GB file only 30 GB of which is in use. In short, the back-up routine 207 of this embodiment can improve the utilization efficiency of the logical volume 120.

### (Automatic Back-Up Processing)

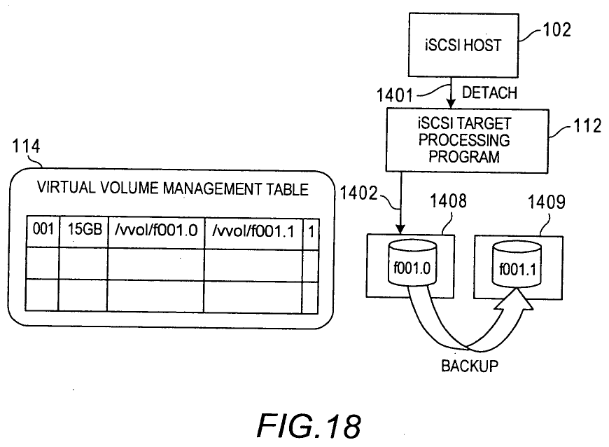

FIG. 18 is an explanatory diagram of automatic back-up processing of the integrated NAS system 104 according to this embodiment.

A file f001.1 (denoted by 1409) is a backup file of a file f001.0 (denoted by 1408).

The iSCSI target processing program 112 receives from the iSCSI host 102 a detachment instruction, which contains a virtual volume number (1401), and executes automatic back-up processing.

Receiving the detachment instruction, the iSCSI target processing program 112 first disconnects, from the iSCSI host 102, one of the virtual volumes 122 whose virtual volume number is contained in the detachment instruction, thereby cutting off access from the iSCSI host 102 (1402). The iSCSI target processing program 112 then calls up the file system processing program 113 and gives an instruction to take a backup of the file f001.0 (denoted by 1408). Receiving the instruction, the file system processing program 113 backs up the file f001.0 (denoted by 1408) to the file f001.1 (denoted by 1409).

FIG. 19 is a flow chart of processing of the iSCSI detachment routine 204 which is contained in the iSCSI target processing program 112 according to this embodiment.

The iSCSI detachment routine 204 receives a detachment instruction from the iSCSI host 102, and starts processing (S701).

The iSCSI detachment routine 204 next selects the entry E of the virtual volume management table 114 whose virtual volume number 301 matches the virtual volume number V contained in the detachment instruction. From the selected entry E, the iSCSI detachment routine 204 extracts the file name 303 and the backup name 304 (S702).

Then the iSCSI detachment routine 204 sends a back-up instruction to the back-up routine 207 (S703). The back-up instruction is a request to copy a file that has the extracted file name 303 to a file having the backup name 304, and starts up the back-up routine 207, which has been described above with reference to FIG. 17.

Next, the iSCSI detachment routine 204 deletes from the cache management table 115 every entry whose virtual volume number 306 matches the virtual volume V contained in the detachment instruction (S704).

The iSCSI detachment routine 204 then stores “0” as the used flag 305 of the entry E selected in the step S702 (S705).

Thereafter, the iSCSI detachment routine 204 disconnects, from the iSCSI host 102, the file having the file name 303 that has been extracted in the step S702 (S706).

In the integrated NAS system 104 of this embodiment, a file can automatically backed up upon detachment of a virtual volume in the manner described above. The integrated NAS system 104 is thus capable of reducing the cost of managing back-up tasks.

Also, the integrated NAS system 104 of this embodiment takes a backup of the files 121 created in the virtual volumes 122 that are disconnected from the iSCSI host 102. This means that the files 121 are backed up when their data is in stasis, and the integrated NAS system 104 thus can execute back-up securely.

### (Restoration Processing)

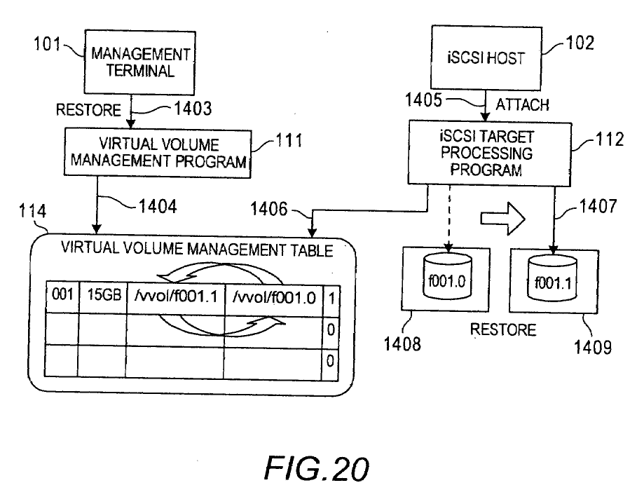

FIG. 20 is an explanatory diagram of restoration processing of the integrated NAS system 104 according to this embodiment.

The virtual volume management program 111 receives a restoration instruction, which contains a virtual volume number, from the management terminal 101 (1403). The management terminal 101 issues a restoration instruction only for the virtual volumes 122 that are disconnected from the iSCSI host 102.

The virtual volume management program 111 then selects an entry of the virtual volume management table 114 whose virtual volume number 301 matches the virtual volume number contained in the restoration instruction. Next, the virtual volume management program 111 switches the file name 303 and the backup name 304 in the selected entry (1404).

The virtual volume management program 111 thus restores a virtual volume.

Next, the iSCSI host 102 instructs the iSCSI target processing program 112 to attach the virtual volumes 122 (1405). At this point, the iSCSI host 102 issues the attachment instruction without considering whether the virtual volumes 122 that are to be attached have been restored or not. The attachment instruction contains a virtual volume number.

The iSCSI target processing program 112 selects an entry of the virtual volume management table 114 whose virtual volume number 301 matches the virtual volume number contained in the attachment instruction, and extracts the file name 303 of the selected entry from the virtual volume management table 114 (1406).

The iSCSI target processing program 112 connects the file f001.1 (denoted by 1409) that has the extracted file name 303 to the iSCSI host 102 (1407). Prior to the restoration, the file f001.0 (denoted by 1408) has been connected to the iSCSI host 102.

FIG. 21 is a flow chart of processing of the restoration routine 202 which is contained in the virtual volume management program 111 according to this embodiment.

The restoration routine 202 receives a restoration instruction from the management terminal 101, and starts processing (S501).

The restoration routine 202 then selects the entry E of the virtual volume management table 114 whose virtual volume number 301 matches the virtual volume number V contained in the restoration instruction (S502).

From the selected entry E, the used flag 305 is extracted. The restoration routine 202 judges whether the extracted used flag 305 is “1” or not (S503).

When the used flag 305 is “1”, it is judged that the virtual volumes 122 instructed to be restored are connected to the iSCSI host 102 and cannot be restored. The restoration routine 202 accordingly notifies the management terminal 101 of the error (S504).

When the used flag 305 is “0”, on the other hand, it is judged that the virtual volumes 122 instructed to be restored are disconnected from the iSCSI host 102 and can be restored. The restoration routine 202 accordingly switches the file name 303 and the backup name 304 (S505), and ends the processing.

The restoration routine 202 thus executes the restoration processing of the integrated NAS system 104.

In some cases, a NAS processed by a blade server restores a virtual volume frequently. This is because restoration is executed each time, for example, a failure occurs in the blade server, or downgrading which accompanies a failure in applying a security patch occurs. Restoration in a conventional NAS is accomplished by assigning a new virtual volume number or by copying data to a file to be restored, which makes the load given by restoration large and hinders quick restoration.

The integrated NAS system 104 of this embodiment, in contrast, does not assign a new virtual volume number, nor make a copy of data, and is capable of instant restoration.

While the present invention has been described in detail and pictorially in the accompanying drawings, the present invention is not limited to such detail but covers various obvious modifications and equivalent arrangements, which fall within the purview of the appended claims.

What is claimed is:

1. A storage system comprising:
a network interface coupled to a first computer and a second computer;
a control unit coupled to the network interface; and
a plurality of disk apparatuses coupled to the control unit,
wherein the plurality of disk apparatuses store data based on a logical address,
wherein the control unit:
has a cache management table, a block access processing part, and a file access processing part;
provides the first computer with virtual volumes and the second computer with files via the network interface; and
determines whether an entry corresponding to a virtual volume included in a block access including a virtual volume sent from the first processor exists in the cache management table,
wherein if the entry exists in the cache management table, the control unit accesses a disk apparatus based on a logical address related to the entry by using the block access processing part, and
wherein if the entry does not exist in the cache management table, the control unit:
specifies a file corresponding to the requested virtual volume;
specifies a logical address related to the file corresponding to the requested virtual volume and accesses a disk apparatus based on the logical address by using the file access processing part; and
adds a new entry related the requested virtual volume to the cache management table.

2. The storage system according to claim 1, wherein the control unit includes a cache memory that stores the relationship between the virtual volume and the logical address.

3. The storage system according to claim 2, wherein the control unit updates the cache memory when the control unit accesses the logical address related to the file, with the logical address and the virtual volume.

4. The storage system according to claim 3, wherein the control unit receives a request for a file from the second computer via the network interface and accesses the disk apparatus based on the logical address related to the file.

5. The storage system according to claim 1, wherein the control unit comprises:
a file creating module which creates the file in a logical volume;
an arrangement information management module which manages information on an arrangement of the file created in the logical volume; and
a file presenting module which presents the file created in the logical volume as a virtual volume based on the arrangement information,
wherein, upon reception of a request to allocate the virtual volume, the file creating module does not create a file to be presented as the virtual volume designated by the allocation request, and
wherein, when the virtual volume is accessed for the first time, the file creating module creates the file to be presented as the virtual volume designated by the allocation request.

6. The storage system according to claim 5, wherein the control unit further comprises:
a back-up module which makes a copy of the file,
wherein, upon completion of access to the virtual volume, the back-up module copies the file presented as the virtual volume by the file presenting module, to another file, and
wherein, upon reception of a restoration request, the file presenting module presents the another file as the virtual volume.

7. The storage system according to claim 6,
wherein the storage system stores association information which indicates an association between an area of the file and an area of the logical volume,
wherein the back-up module identifies, from the area of the file, an unused area to which no area of the logical volume is allocated from the area of the file, based on the association information, and
wherein, when copying data of the file presented as the virtual volume to the another file, the back-up module does not allocate the logical volume to the unused area identified.

8. A logical volume management method for a storage system, the storage system comprising a network interface coupled to a first computer and a second computer, a control unit coupled to the network interface, and a plurality of disk apparatuses coupled to the control unit, wherein the plurality of disk apparatuses store data based on a logical address, and wherein the control unit comprises a cache management table, a block access processing part, and a file access processing part, the method comprising:
providing, by the control unit, the first computer with virtual volumes and the second computer with files via the network interface;
determining, by the control unit, whether an entry corresponding to a virtual volume included in a block access including a virtual volume sent from the first processor exists in the cache management table;
if the entry exists in the cache management table, accessing, by the control unit, a disk apparatus based on a logical address related to the entry by using the block access processing part; and
if the entry does not exist in the cache management table:
specifying, by the control unit, a file corresponding to the requested virtual volume;
specifying, by the control unit, a logical address related to the file corresponding to the requested virtual volume and accesses a disk apparatus based on the logical address by using the file access processing part; and
adding, by the control unit, a new entry related the requested virtual volume to the cache management table.

9. The logical volume managing method according to claim 8, wherein the control unit includes a cache memory, and further comprising:
storing, by the cache memory, the relationship between the virtual volume and the logical address.

10. The logical volume managing method according to claim 9, further comprising:
updating, by the control unit, the cache memory when the control unit accesses the logical address related to the file, with the logical address and the virtual volume.

11. The logical volume managing method according to claim 10, further comprising:
receiving, by the control unit, a request for a file from the second computer via the network interface; and
accessing, by the control unit, the disk apparatus based on the logical address related to the file.

12. The logical volume managing method according to claim 8, wherein the control unit comprises a file creating module which creates the file in a logical volume, an arrangement information management module which manages information on an arrangement of the file created in the logical volume, and a file presenting module which presents the file created in the logical volume as a virtual volume based on the arrangement information, the method further comprising:
upon reception of a request to allocate the virtual volume, not creating by the file creating module, a file to be presented as the virtual volume designated by the allocation request, and
when the virtual volume is accessed for the first time, creating, by the file creating module, the file to be presented as the virtual volume designated by the allocation request.

13. The logical volume managing method according to claim 12, wherein the control unit further comprises a back-up module which makes a copy of the file, the method further comprising:
upon completion of access to the virtual volume, copying, by the back-up module, the file presented as the virtual volume by the file presenting module, to another file; and
upon reception of a restoration request, presenting, by the file presenting module, the another file as the virtual volume.

14. The logical volume managing method according to claim 13, further comprising:
storing, by the storage system, association information which indicates an association between an area of the file and an area of the logical volume; and
identifying, by the back-up module, from the area of the file, an unused area to which no area of the logical volume is allocated from the area of the file, based on the association information,
wherein, when copying data of the file presented as the virtual volume to the another file, the back-up module does not allocate the logical volume to the unused area identified.
